(19) United States
(12) Patent Application Publication
(10) Pub. No.: US 2014/0249860 A1
(43) Pub. Date: Sep. 4, 2014

(54) VOICE RECOGNITION MEDICAL CODING APPLICATION

(71) Applicant: Michael RYNCHEK, Minneapolis, MN (US)

(72) Inventor: Michael RYNCHEK, Minneapolis, MN (US)

(21) Appl. No.: 14/196,283

(22) Filed: Mar. 4, 2014

Related U.S. Application Data
(60) Provisional application No. 61/772,140, filed on Mar. 4, 2013.

(51) Int. Cl. G06F 19/00; G10L 15/26

(52) U.S. Cl. CPC G06F 19/328; G10L 15/26
USPC 705/3

(57) ABSTRACT

The invention relates to an apparatus and method for a using voice recognition technology for medical coding purpose. In particular, the invention comprises a system, and preferably a mobile application, to use voice recognition to translate human speech into medical diagnostic codes.

### RELATED APPLICATIONS

The present application claims priority to and incorporates by reference thereto, U.S. Provisional Patent Application No. 61/772,140 filed on Mar. 4, 2013.

### BACKGROUND

1. Field of the Invention

This invention relates to an apparatus and method for a using voice recognition technology for medical coding purpose. In particular, the invention comprises a system, and preferably a mobile application, to use voice recognition to translate human speech into medical diagnostic codes.

2. Background of the Invention

To fully understand the benefits of the app, let us first consider the current process of coding medical information upon a visit with a health care professional.

After a doctor visit is complete, a doctor, nurse, or office assistant creates a record of the purpose and outcome of the visit. This information is recorded in one of two ways: 1) the event is transcribed; or 2) the event information is entered into the patient's Electronic Medical Record (EMR). In either occurrence, the next step is to have a Certified Medical Coder (CMC) translate, or code, the diagnosis into a number format. With a number assignment, the information can be sent to the payer for reimbursement.

The process is fraught with inefficiencies an unnecessary encumbrances, as well as being susceptible to errors. Coding is very labor intensive, complex, and the demands thereon have only increased with the advent of EMR systems. Without comprehensive EMR formats, and the myriad of coding systems that must be navigated, and the every changing nature of existing coding protocols, the system has generally just added layers of complexity and increased the opportunity for error.

Accordingly, there is a need for an improved method of medical coding.

### BRIEF DESCRIPTION OF THE DRAWINGS

FIG. 1 is a block diagram of the systems of the present invention.

FIG. 2 is a screen shot of a password screen of the present invention.

FIG. 3 is a screen shot of a record and edit screen.

FIG. 4 is a screen shot of a text and code screen.

FIGS. 5-9 depict a flow chart of the present invention.

### DETAILED DESCRIPTION OF THE PREFERRED EMBODIMENTS

The present invention substantially eliminates the CMC coder by automating the process of converting the patient information to code, thereby avoiding the need for a CMC to perform that function. The present invention functions similarly to that of a robot arm in an assembly line; it is inserting an automated step into an already established process, like a plugin. The present invention comprises a software application that has the ability to integrate into most hospital's billing systems and EMR claiming databases. It does not require a complete transfer to a new coding system but optimizes the current system. By implementing the present invention there are several predicated outcomes.

First, the invention removes steps and consolidates processes to increase efficiencies, and ultimately, expedite the billing process. In addition, as these processes are streamlined there are decreased costs of operation. By eliminating one step of interpretation between the doctor and coder there is improved accuracy within the personal health information and medical records.

In this case, particularly, the cost of a CMC is eliminated. Instead, a CMC can act as a medical coding auditor to review and approve the results of the present invention. Instead of performing the coding, the CMC merely reviews the results of the coding process. This minimizes human error and miscoding, and also eliminates costs associated with such errors. Finally, as the coding process is refined, it will be dramatically faster, nearly real-time.

The present invention consists of three components: a client program, an API server, and a speech-to-text service (STT). The present invention can be implemented with a variety of commercially available STT services.

To begin, the client program (in the one preferable case, an iPad application) records an audio Wave file consisting of a dictated description of a medical/health services session. The client programs then indicates which STT will be used for speech-to-text conversion (the invention contemplates using a variety of STTs. The application can be used on a variety of platforms, and with virtually any computing device with a microphone including: Desktop computers (both Macs and PCs), mobile phones, hand-held devices, tablet computers, etc.

A user begins the process by recording a session and dictates the results of some medical or health care service session. When the user indicates that they are finished recording (through a stop button, for example), the audio file is sent to the API server.

First, the API server converts the audio file to the format required by the selected STT service. Afterwards, the SST service accepts the audio file and returns a textual transcription. To parse this information the present invention uses Nuance and/or Google's STT algorithms (other algorithms can be used as well). At this point, the API server splits the information into logical chunks using periods, commas or a key word such as “break.”

Next, for each parsed section, the API server queries a search engine utility. For example the present invention can use Apache's Lucene (or similar systems). The search engine utility has been pre-loaded with a massive index of information (for the coding library such as the ICD10 library) and will return an entry most highly correlated to the parsed segment of text sent. The response from the search engine utility is then sent to the original client device.

The advantage of the application is the capability to integrate with client systems (in this case, a hospital or clinic's patient information, scheduling and/or billing system). Upon manipulating the response from the API server, the client application can send the resulting data back to the API server for secure storage of sensitive information off the device.

This allows the API to act as a central hub, both gathering information for the client application (for example, a list of today's patients) as well as communicating this information to the intended recipients, such as a clinic's billing system. It is important to note that all stored information is appropriately encrypted and transferred to ensure data integrity and meet security and privacy standards.

Any act of retrieving or setting information in this data store triggers an event that can be hooked. This way the system can adapt quickly to various external systems in a modular fashion by creating custom means of exchanging the desired information. (For example, in a clinic, the system would create a custom interface with the particular EMR or patient information and billing systems.) This allows for real time transcription and billing. Used optimally, an insurer could receive a bill as the patient is exiting the clinic.

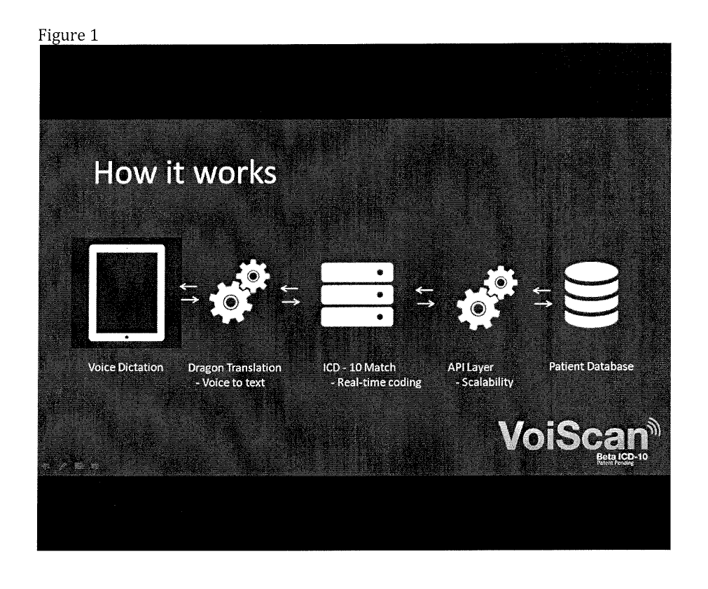

Referring to Figures below, and the attached flow chart, the operation of the application will be described. FIG. 1 shows a block diagram of the components of the present invention. The invention includes an application running on a computing device; in this case running on a tablet computer such as the iPad (of course the invention is not so limited).

The application is in operative communication with the following: a STT, such as Nuances Dragon voice to text conversion utility; an ICD 10 database which can be searched using for example a Lucene based JAVA tool; a patient database such as the kind associated with an EMR/HER product for example like the product provided by Epic Systems Corporation; and an API that handles all communication between the parts described herein.

The application begins operation by loading a patient dataset into the user computer (tablet computer for example). The patient dataset would consist of a doctor's patients for the day, or for some other applicable time period. The information is obtained from the patient database/scheduling system through the API.

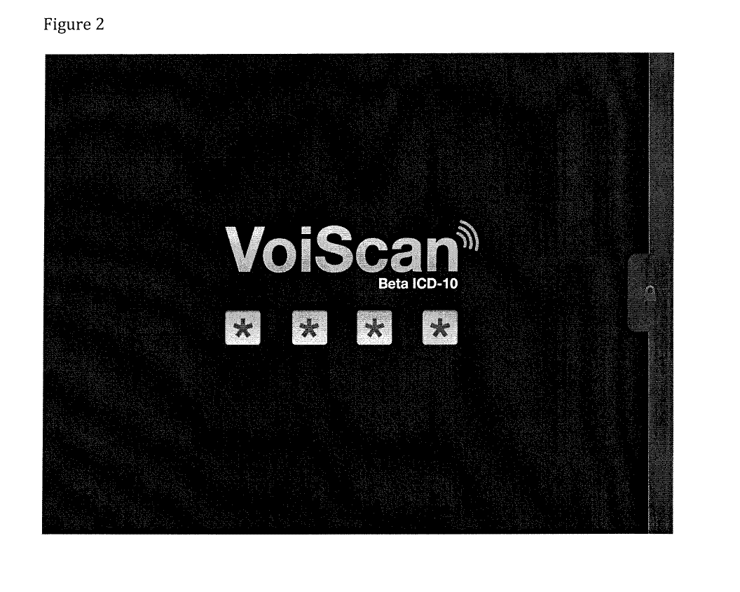

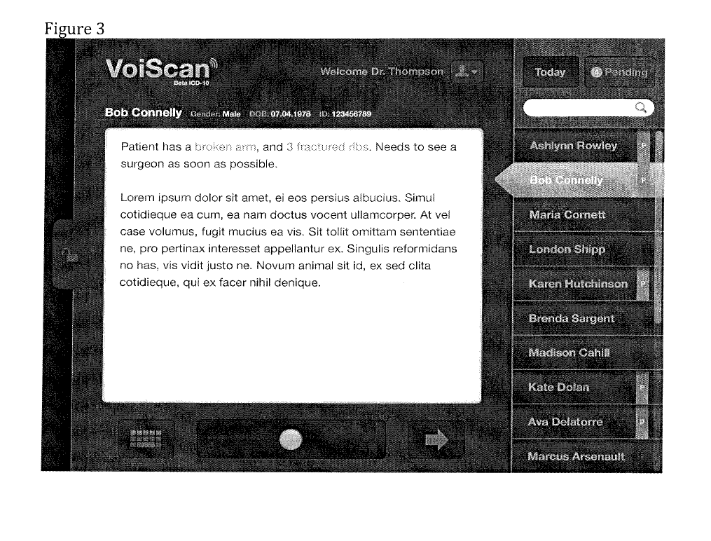

Next, the user would enter a security code into the user device to open the application, as shown in FIG. 2. In operation, the user device would then display the screen shown in FIG. 3. The doctor, after or during a patient visit, selects the patient from the list on the right. Then would press the record button at the bottom center of the screen to dictate notes on the patient visit, which would be stored in an audio file. The notes are the converted to text to using the STT utility, and essentially instantaneously appearing in the text window in the center of the screen show in FIG. 3.

The doctor also has the ability to press the keypad icon on the lower left of the screen, and either enter or edit the text. The patient list includes patients that have pending descriptions, which are indicated by the “P” designation, and patients with no designation because they have not yet been seen or the doctor has already processed their entry.

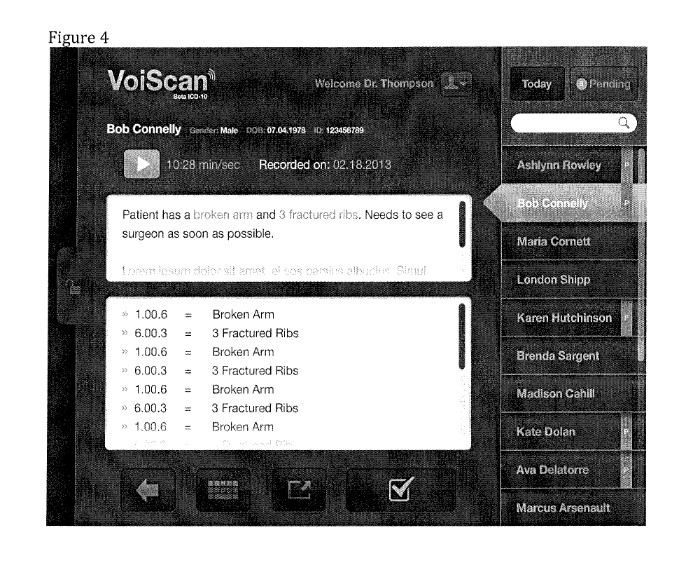

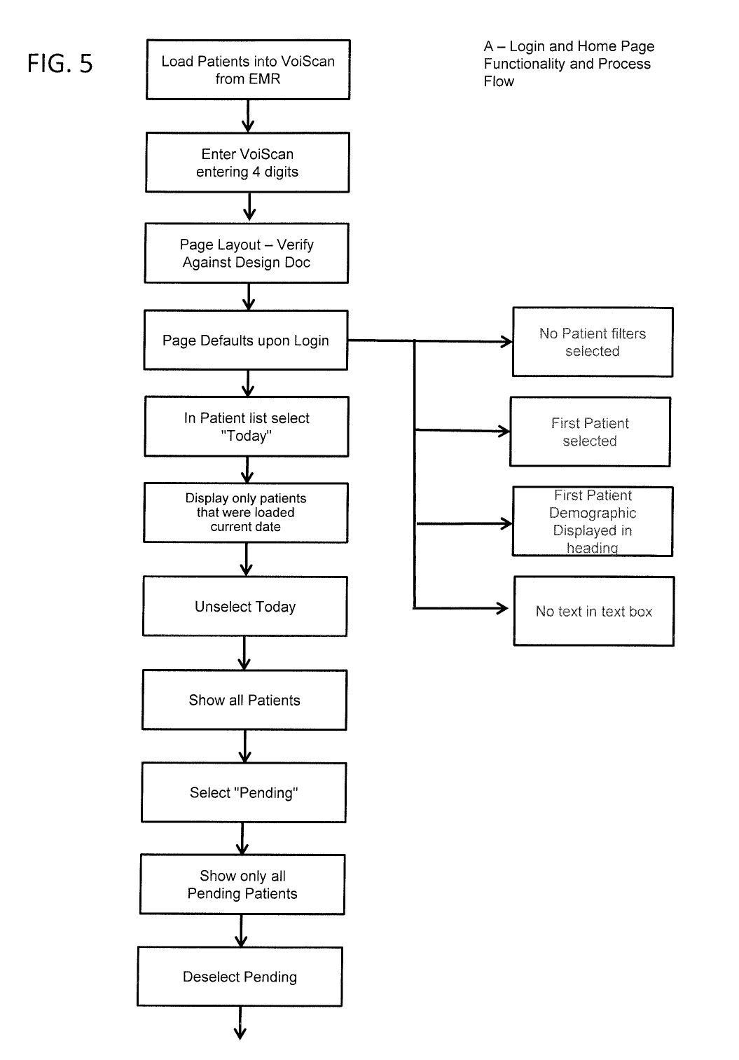

Pressing the arrow at the bottom right of the screen takes the application to the screen shown in FIG. 4. At this point, the application has not only translated the voice information to text, but has correlated the text to ICD 10 codes using the database search utility. The application now displays the text summary by the codes as well. This conversion has been place essentially instantaneously, and also automatically. The application includes a keyboard icon that allows for editing of the entry by either the doctor or a medical coder. Additionally, the box/arrow icon at the bottom of the screen allows the user to email or print the entry. The arrow key at the bottom left allows the user to go back to the prior screen. The box/check mark icon on the lower right of the screen allows the user to complete the entry thereby submitting the information to the EMR application for billing. An arrow at the top left of the screen allows the user to listen to the recorded entry for review purposes.

The invention also makes use of active sync technology that can synchronize the application on the tablet with other user devices such as a desktop or smart phone. This allows the user to access the application and the information therein on different devices and more or less instantaneously.

The application also includes a lock icon on the center left that allows the user to return the application to the lock screen shown in FIG. 2 at any time. Additional detail on the functioning and flow of the invention is depicted in the attached flow chart.

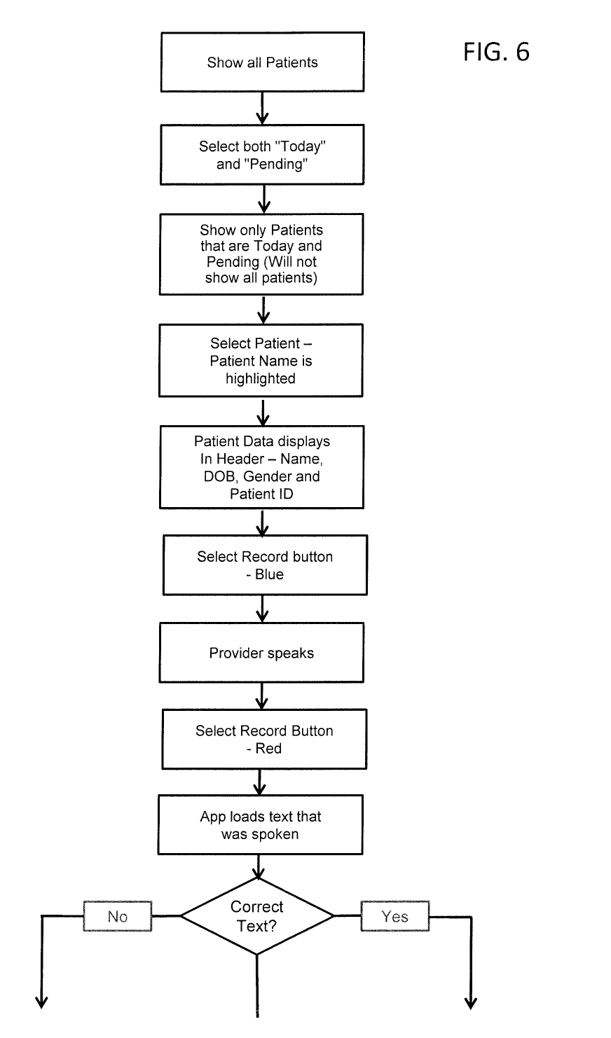

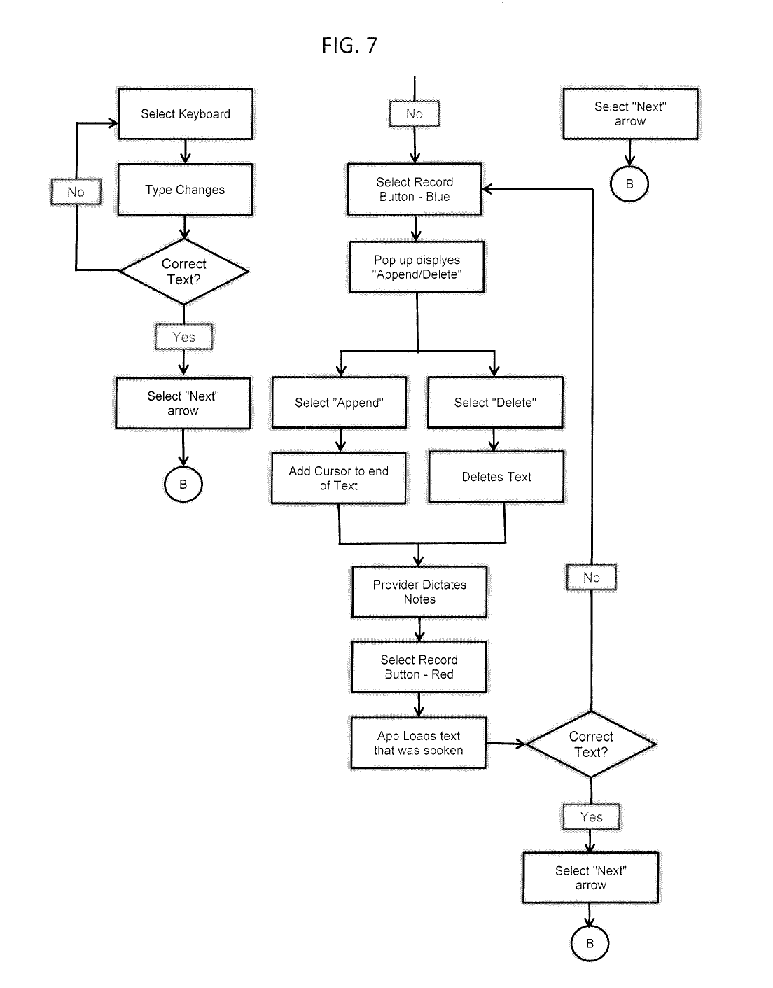

In particular, Figure shows the general flow described above. The loading of the application with patient information, and the patient selection and filters are described. FIG. 6 further described the recording process, and the conversion of the speech to text. Next, the user has the option to correct the text (or add additional text). This is described in FIG. 7. If the user decides to alter the text, they select the keyboard icon and enter the text.

FIG. 7 shows that the user has the option to further alter the text by appending additional voice recording which is then converted to text. The user is allowed to further edit of refine the text as described above.

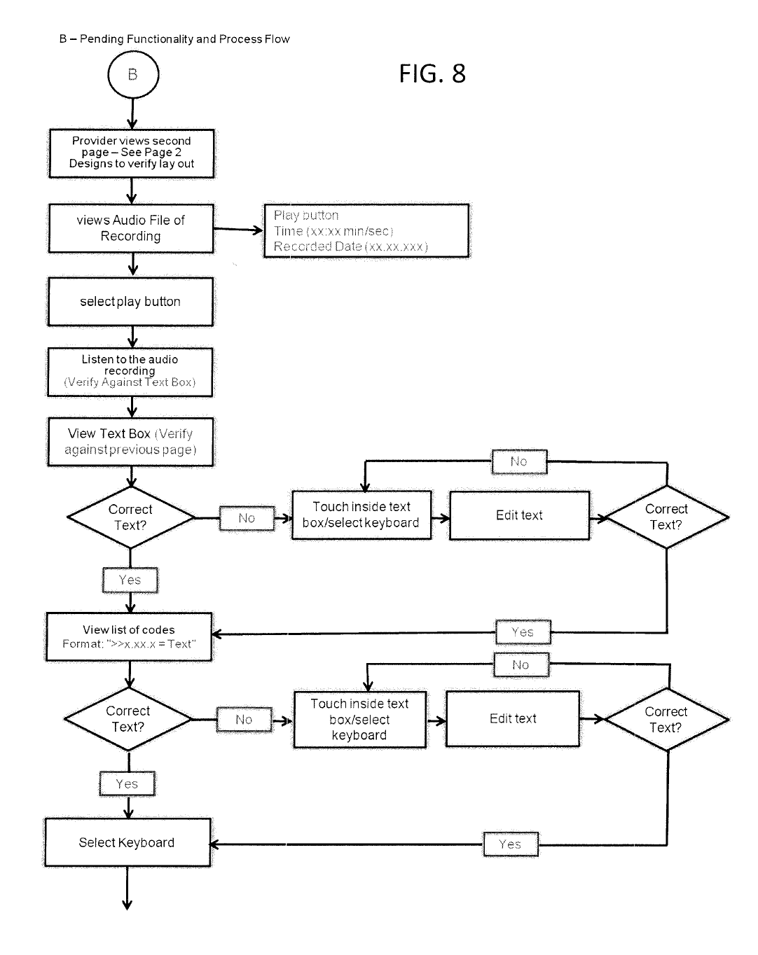

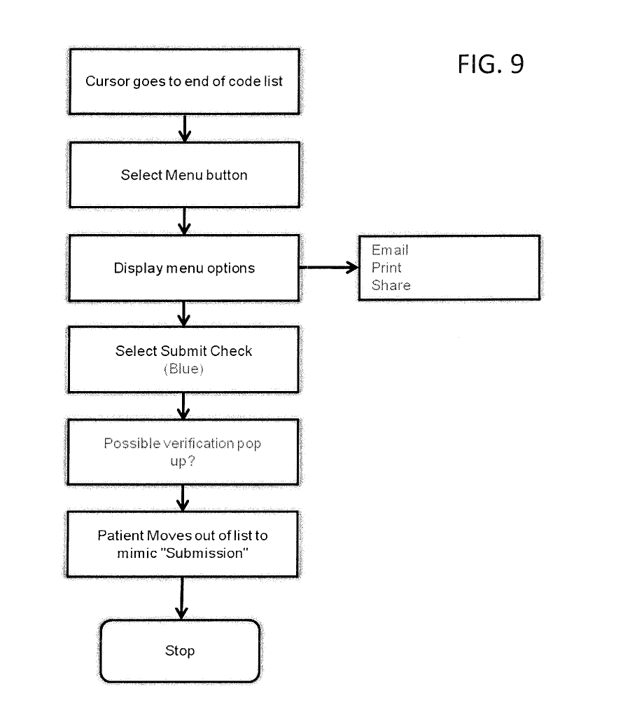

FIG. 8 shows the process flow once the text file has been created, codes created, and the information is passed on for code review. The review has the option to review the text, audio, and code information and make any corrections that might be appropriate. Once, this process is complete the information is then sent on to complete the billing and payment information.

In the manner described herein the invention substantially eliminates the drawback of the prior art. In particular, in the past the process described above was performed by human coders. The coders would receive transcribed text and then would have to manually create the coded entries, either from having committed the codes to memory or repeatedly looking them up in a database.

The present invention eliminates this step by automating the process and allows the human coder to simply audit or review the entry after the transcription and coding is complete. The advantages of this include, decreased costs in form of reduced operational costs, reduction in misprocessing by elimination of human coding errors, and reducing the cost in terms of reducing the burden on the CMC's. This is particularly important given the costs associated with the transition from ICD9 to ICD10, where the present invention will eliminate a great portion of the transition costs.

While the preferred embodiment of the invention has been described in reference to the foregoing disclosure, the invention is not so limited.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods, and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention.

1. A computer implemented method for medical coding, the method being performed by execution of computer readable program code by at least one processor of at least one computer system, the method comprising:
obtaining patient data from a database;
creating a voice file documenting a patient visit;
converting the voice file to a text file; and
correlating the text file to medical codes.

2. The invention of claim 1 wherein the converting step utilizes an SST service.

3. The invention of claim 1 the medical codes are ICD10 codes.

4. The invention of claim 1 further comprising the step of integrating the method into an EMR program.

5. The invention of claim 1 further comprising the step of presenting multiple patients from which to select the data.

6. The invention of claim 1 further comprising the step of presenting the text and codes on a display screen.

7. The invention of claim 1 further comprising the step of editing the text.

8. The invention of claim 1 providing and API layer for executing the method on a plurality of different systems.

9. The invention of claim 1 further comprising the step of submitting the codes for payment processing.

10. The invention of claim 1 further comprising the step of appending documentation relating to the patient visit.

11. The invention of claim 1 wherein the text and codes appear substantially simultaneously with the recording.
